(19) United States
(12) Patent Application Publication
(10) Pub. No.: US 2009/0150823 A1
(43) Pub. Date: Jun. 11, 2009

(54) Apparatus and Method for Improved Window Management in a Grid Management System

(75) Inventors: Stephen Orr, Markham (CA); Borislav Zahariev, Markham (CA)

Correspondence Address: ADVANCED MICRO DEVICES, INC.;C/O VEDDER PRICE P.C., 222 N.LASALLE STREET, CHICAGO, IL, 60601, US

(73) Assignee: ATI Technologies ULC, Markham (CA)

(21) Appl. No.: 11/953,296

(22) Filed: Dec. 10, 2007

(51) Int. Cl. G06F 3/048

(52) U.S. Cl. 715/788

(57) ABSTRACT

An apparatus is operative to output display data for displaying a first application window and a second application window, wherein each application window is associated with an active application. The apparatus attaches the first application window with a first grid section using a grid management system, and based on user input associated with the second application window, performs a grid-based operation, such as swapping, splitting, or sharing. A method is also described that includes one or more of a grid-based swapping operation, a grid-based splitting operation, and a gird-based sharing operation.

### FIELD OF THE DISCLOSURE

The disclosure generally relates to managing application windows in a desktop environment and more particularly to managing application windows in a desktop environment that employs a grid management system.

### BACKGROUND OF THE DISCLOSURE

As computers become more powerful and software applications are developed to help accomplish more and more tasks, computer users become more dependent on computers to accomplish tasks. As this use increases, computer users often find themselves using multiple software applications simultaneously. For example, increases in memory and processing power in addition to higher resolution displays allow computer users to have multiple applications open, which may include, for example, several word processing documents, multiple web browsers, along with other programs, such as graphics programs, gaming applications, and many other software applications. Simultaneously using several computer applications has advantages. For example, a user may switch between one or more applications without having to wait for an application to load. However, when a computer user has several software applications open, it oftentimes becomes difficult to organize a display of the windows on the display. In other words, having a large monitor with many application windows open leads to desktop clutter. Thus, among other things, it may become difficult to position application windows to keep application windows organized.

One solution that exists to overcome this problem is a grid management system, i.e., “grids.” With a grid management system, the user defines an arrangement of rectangular cells that divide the desktop. Open application windows may be attached to a specific grid cell (i.e., a grid section) or may be left detached, i.e., floating. When an application window is attached to a grid section, the application believes it is in a maximized state, yet the grid management system does not allow the application window to display on the entire screen of a display, as most often occurs when an application window is typically maximized in a windowing-based system.

For example, referring to FIG. 1, a prior art solution of a system 100 utilizing a grid management system is shown. As shown, one or more processing devices 102 may be, for example, a central processing unit. The one or more processing devices 102 may include one or more central processing units (CPUs), distributed processing circuitry, application specific integrate circuits (ASICs), state machines, discrete logic, or any other suitable processing circuitry known in the art. In system 100, the one or more processing devices 102, among other things, execute computer readable code stored in memory 104, i.e., a storage medium. The one or more processing devices 102 is also operatively connected to display 106, which may display, among other things, graphical user interface (GUI) 108. The one or more processing devices may also be operatively coupled to one or more input devices 110. The one or more input devices 110 may include, for example, a mouse, a keyboard, a tablet input pad, or any other suitable device known in the art. Each input device 110 may send and receive input device data 1112 from the one or more processing devices 104.

Memory 104 may send and receive memory data 114, which may go to or come from the one or more processing devices 102. The memory 104 may be any type of memory conventionally known in the art, such as random access memory (RAM), read-only memory (ROM), programmable memory (PROM), erasable PROMs (EPROM), electrically erasable PROM (EEPROM), flash memory, magnetic storage devices (e.g., hard disks, floppy disks, magnetic tape), optical disc drives, or any other suitable non-volatile memory now known or later developed.

The one or more processing devices 102 may execute computer readable instructions stored in memory 104 that cause the one or more processing devices to output display data 116. The computer readable instructions, for example, may be a grid management application or system. The graphical user interface 108 of FIG. 1 illustrates one example of a grid management system known in the art. For example, shown in graphical user interface 108 is a first application window 118 and a second application window 120. Each application window has a title bar. For example application window 118 has title bar 122, and application window 120 has title bar 124. In this particular example, both application windows 118, 124 are detached from the grid. As illustrated by the dotted lines 126 and 128, the grid is divided into four sections: grid section 130, grid section 132, grid section 134, and grid section 136. As known in the art, these grid sections may not be displayed on the screen. Instead, they are simply there, i.e., the user knows that the grid sections are there, in the grid management application may choose to display lines such as lines 126 and 128 to show the grid sections to users, but it is preferred that the grid lines do not show on the display during normal use. Also shown in FIG. 1, is a mouse pointer 138. As known in the art, a user may control the mouse pointer and its location (e.g., a “current location”) and input via an input device 110, such as a mouse, user input to control the positioning and function of mouse pointer 138.

FIG. 2 shows a graphical user interface 108 of FIG. 1. This figure illustrates how a user may attach an application window 118 to a grid section 132. Dotted application window 202 shows the previous positioning of application window 118, i.e., dotted application window 202 represents the previous position of application window 118 as shown in FIG. 1. As represented by line 204, a user has used the mouse pointer 132 to click on title bar 122 of application window 118 and moved the application window 118 over grid section 132. If the grid management application detects that a user is attempting to attach the application window 118 to the grid section 132, the grid management application may actually display dotted lines 126 and 128. A user may provide user input in addition to simply clicking and dragging an application window to indicate that he or she is attempting to attach the application to the grid. For example, a user may press a modifier key on a keyboard, which may include any one key or combination of keys, while performing a drag and drop operation to indicate that he or she is attempting to attach the application window 118 to grid section 132. Furthermore, the grid management application may cause the graphical user interface 108 to show that a user is about to attach an application window 118 to a grid section 132 and to further show to which grid section 132 the attachment will occur. For example, as shown in FIG. 2, the grid lines 126 and 128 may actually be displayed on display 106. Furthermore, the portions of grid lines 126 and 128 that define grid section 132 turn to solid lines in FIG. 2 to indicate that if the user performs the correct action, such as releasing a mouse button, application window 118 will attach to grid section 132.

FIG. 3 illustrates application window 118 being attached to grid section 132. Once the application window 118 is attached to grid section 132, it maximizes to fill the grid section 132 as shown.

As known in the art, grids do not have to divide a display 106 into fourths, as shown in FIGS. 1-3. A grid may contain grid sections that are divided in any suitable way—they may be based on predefined grids that a user may choose through a grid management application, or a user may be able to customize the grids. For example, a grid system is illustrated in FIG. 4 that contains different grid sections than shown in FIGS. 1-3. For example, the graphical user interface 108 contains grid sections 402, 404, 406, and 408. It is understood that a grid management system may contain any suitable number of and arrangement of grid sections.

As one skilled in the art will appreciate, grid management systems allow a user to organize the display and arrangement of application windows on a graphical user interface 108. While useful, known grid management applications are not without their problems. Limitations exist, for example, in current grid solutions when the user is arranging the windows to be attached to a grid. For example, if an application window is attached to a grid section that already has an application window attached to it, the two windows are both added to the grid section with one window being completely obscured by the other. Thus, the obscured window is difficult to access. This problem is further enhanced if even more than two windows are attached to the same grid section.

Another problem arises if a user desires to organize more application windows than there are grid sections when the user does not want more than one application window in the same grid section. If the user wishes to create additional grid sections in such a case, the user must manually edit the grid to divide existing grid sections to create new grid sections to contain the additional application windows. Manually creating grid sections often involves invoking a grid editing mode in the grid management software and giving user input to create new grid sections. Then if a user detaches one of the attached application windows from the grid section, an empty grid section remains. The user must then manually edit the grid again to remove the grid section that is no longer being used.

Yet another problem exists when a user wants to swap one application window that is attached to one grid section with another application window that is attached to a different grid section. To do this, the user must first detach the attached application windows from each grid section, attach the first application window to the new grid section, and then attach the other application window to the other grid section.

Thus there exists a need for a way to more intuitively and more quickly switch between windows that are sharing a grid section, to split an existing grid section to add new grid sections, to merge two grid sections that were previously split, and to swap two windows between grid cells.

### BRIEF DESCRIPTION OF THE DRAWINGS

The disclosure will be more readily understood in view of the following description when accompanied by the below figures and wherein like reference numerals represent like elements, wherein:

FIG. 1 is a diagram illustrating one example of a prior art system utilizing a grid management system.

FIG. 2 is a diagram illustrating one example of a graphical user interface using a grid management system as known in the prior art.

FIG. 3 is a diagram illustrating one example of a graphical user interface using a grid management system as known in the prior art.

FIG. 4 is a diagram illustrating one example of a graphical user interface using a grid management system as known in the prior art.

FIG. 5 is one example of a grid management system on a graphical user interface on a display in accordance with one example embodiment of the disclosure;

FIG. 6 is one example of a grid management system on a graphical user interface on a display in accordance with one example embodiment of the disclosure;

FIG. 7 is one example of a grid management system on a graphical user interface on a display in accordance with one example embodiment of the disclosure;

FIG. 8 is one example of a grid management system on a graphical user interface on a display in accordance with one example embodiment of the disclosure;

FIG. 9 is one example of a grid management system on a graphical user interface on a display in accordance with one example embodiment of the disclosure;

FIG. 10 is one example of a grid management system on a graphical user interface on a display in accordance with one example embodiment of the disclosure;

FIG. 11 is one example of a grid management system on a graphical user interface on a display in accordance with one example embodiment of the disclosure;

FIG. 12 is one example of a grid management system on a graphical user interface on a display in accordance with one example embodiment of the disclosure;

FIG. 13 is one example of a grid management system on a graphical user interface on a display in accordance with one example embodiment of the disclosure;

FIG. 14 is one example of a grid management system on a graphical user interface on a display in accordance with one example embodiment of the disclosure;

FIG. 15 is one example of a grid management system on a graphical user interface on a display in accordance with one example embodiment of the disclosure;

FIG. 16 is one example of a grid management system on a graphical user interface on a display in accordance with one example embodiment of the disclosure;

FIG. 17 is a flowchart illustrating one example of a method for performing a grid-based management operation in accordance with one example embodiment of the disclosure; and

FIG. 18 is a flowchart illustrating one example of a method for performing a grid-based management operation in accordance with one example embodiment of the disclosure.

### DETAILED DESCRIPTION OF THE PREFERRED EMBODIMENTS

In one example, an apparatus is operative to output display data for displaying a first application window and a second application window, wherein each application window is associated with an active application. The apparatus attaches the first application window to a first grid section using a grid management system, and based on user input associated with the second application window, performs a grid-based swapping operation that causes the first application window to detach from the first grid section and the second application window to attach to the first grid section. The grid-based swapping operation also causes the first application window to either attach to the second grid section if the second application window was attached to the second grid section before the swapping operation or to remain detached if the second application window was detached from the grid before the swapping operation. Also, in one example, based on the user input and a current screen position, the apparatus outputs visual indication data, such as graphics data for a display, for displaying an indication on a display that a user will perform the grid-based swapping operation if a drop (e.g., a release of a mouse button in a drag and drop operation, as known in the art) occurs at the current screen position.

In another example, the apparatus performs a grid-based splitting operation that causes the first grid section to divide into a first new grid section and a second new grid section and that further causes the first application window to attach to the first new grid section and the second application window to attach to the second new grid section. Based on the user input and a current screen position, the apparatus determines the properties of the first new grid section and the properties of the second new grid section. Furthermore, visual indication data is output for displaying an indication that a user will perform a grid management operation, such as a grid-based splitting operation. If an application is detached from one of the new grid sections, the two new grid sections may form a merged grid section.

In another example, the apparatus performs a grid-based sharing operation that places both the first application window and the second application window in the grid section and allows direct user control through a graphical user interface over displaying either the first application window in the grid section or the second application window in the grid section. The user control may be received, for example, via a tab bar, a next/previous button, or a context menu.

Among other advantages, users will be able to gain all of the advantages associated with grid management systems while being able to more quickly and more intuitively interact with the grid management system. Thus, users will be able to more quickly perform grid-based operations, thereby enhancing organization of open application windows and increasing user productivity.

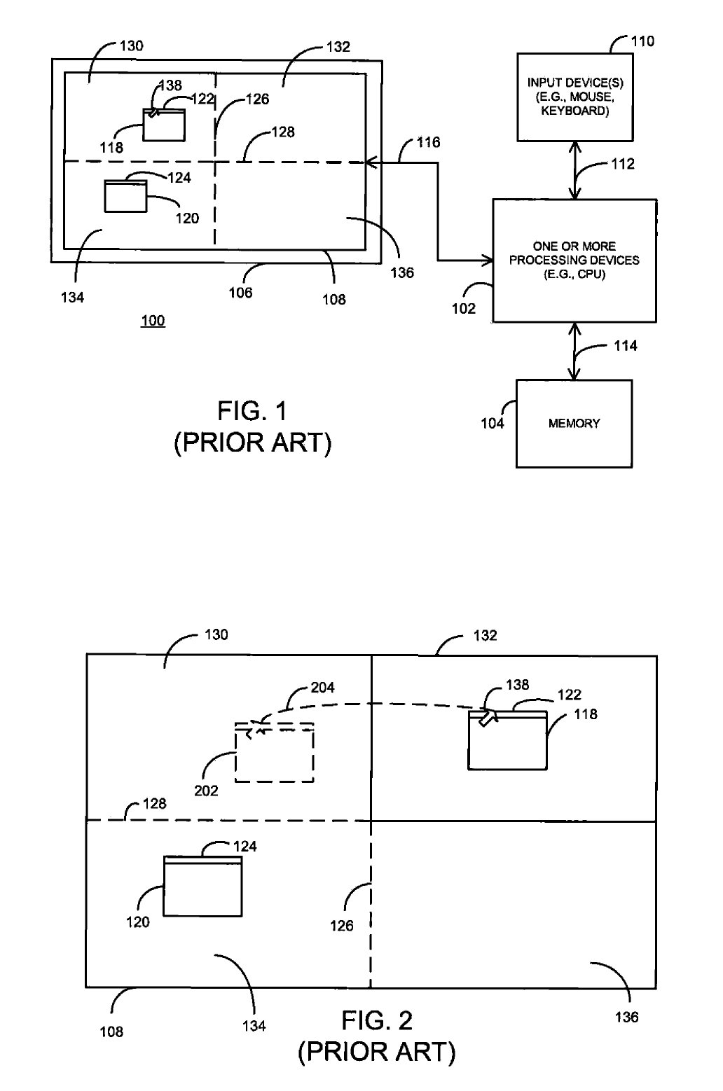

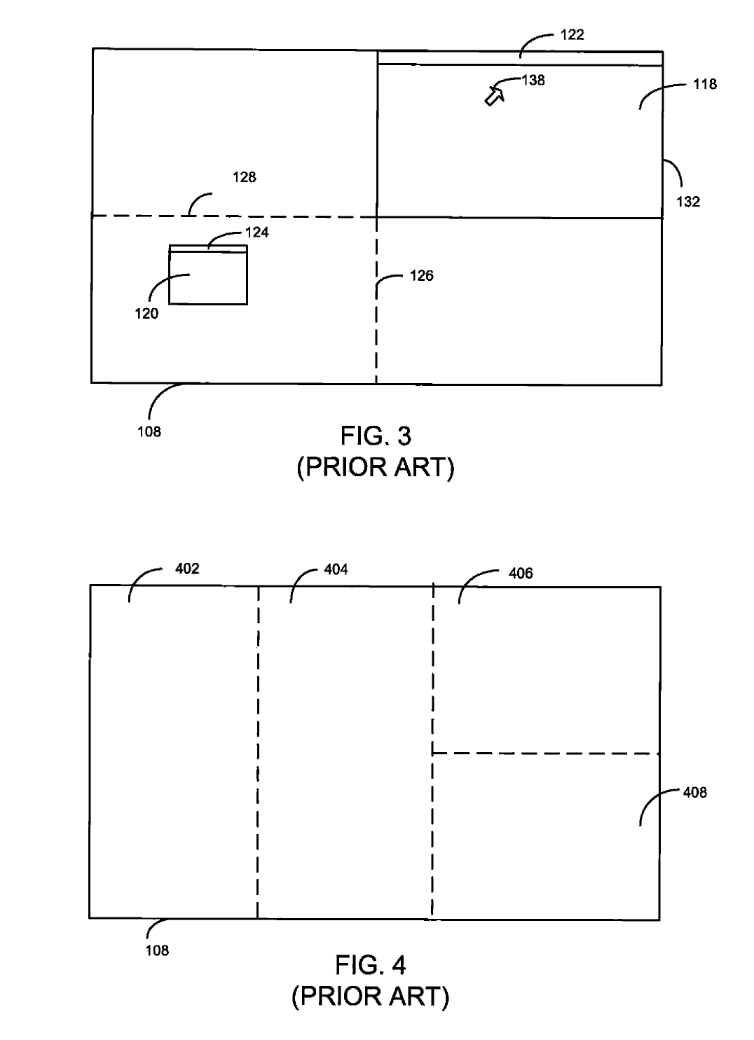

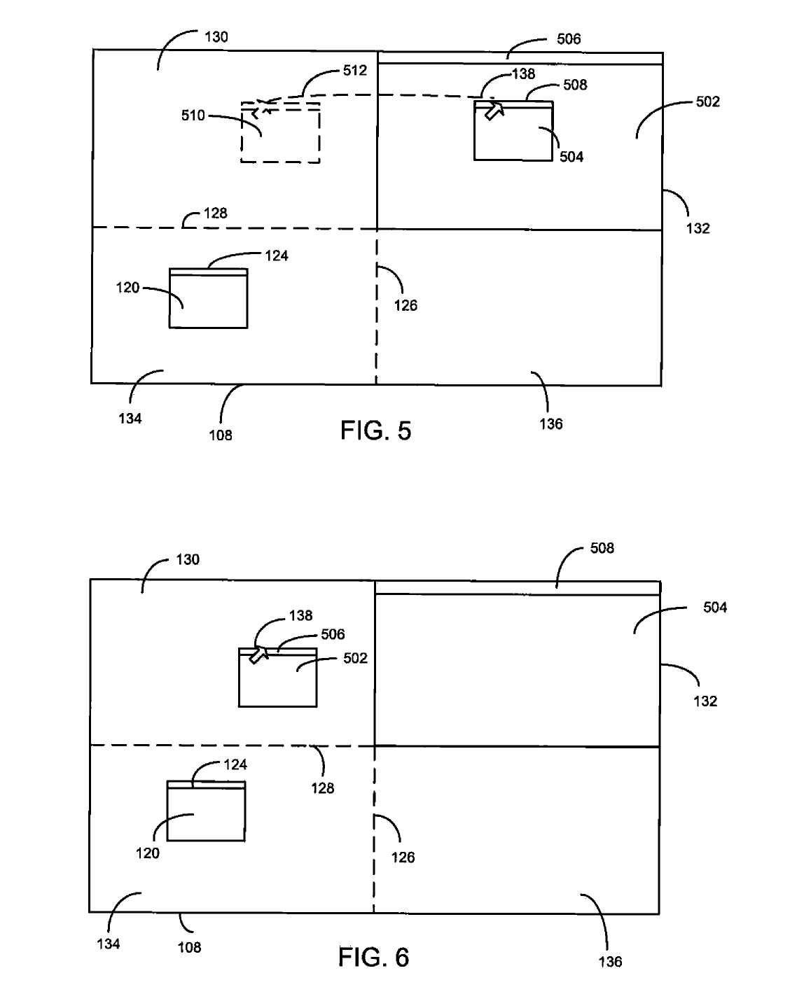

One example embodiment is best understood in view of FIGS. 5 and 6. FIG. 5 illustrates the graphical user interface 108 containing a grid defined by grid lines 126, 128. This graphical user interface 108 may be in an apparatus such as that shown in FIG. 1, which may, among other things, contain one or more processing devices (not shown), input devices (not shown), and memory (not shown). In this example, memory containing stored readable instructions executable by one or more processing devices, when executed by the one or more processing devices, cause the one or more processing devices to output display data for displaying a first application window 502 and a second application window 504, wherein each application window is associated with an active application. As known in the art, applications may consist of word processing applications, multimedia applications, internet or email applications, or any other suitable application. As shown in FIG. 5, application window 502 has title bar 506 and is attached to grid section 132. The first application window may be attached to the first grid section 132 via any suitable means permitted by the grid management system, such as by dragging and dropping the application window 506, while pressing a modifier key combination, or by right clicking on title bar 506 and selecting, from a context menu, an option such as “Attach to grid,” or by any other suitable mechanism.

Second application window 504 has title bar 508. Based on user input associated with the second application window 504, the one or more processing devices performs a grid-based swapping operation, without any further user input, that causes the first application window 502 to detach from the first grid section 132, the second application window 504 to attach to the first grid section 132, and the first application window 502 to either attach to a second grid section, such as grid section 130, 134, or 136, if the second application window 504 was attached to the second grid section before the swapping operation or to remain detached if the second application window 504 was detached from the second grid section before the swapping operation.

Thus, for example, FIG. 5 shows second application window 504 detached from the grid. The second application window's original position is represented by application window 510 in dotted lines, and the user input 512 is represented by a dotted line. In this example, the user provides user input 512 to drag and drop second application window 504, perhaps while holding down one or more modifier keys (e.g., any key combination on a keyboard input device, as known in the art), onto grid section 132, to which first application window 502 is attached. As shown in FIG. 5, portions of grid lines 126, 128 forming grid section 132 may become solid lines to indicate to a user that the user will perform a grid-based swapping operation with grid section 132 if a drop occurs at this location. In response to the user input 512, first application window 502 becomes detached from grid section 132 and second application window 504 attaches to grid section 132. In this example, the second application windows 508 was originally detached from the grid, as represented by dotted application window 510 prior to receiving user input 512. Thus, this example of a grid-based swapping operation places first application window 502 in a detached position, as illustrated in FIG. 6.

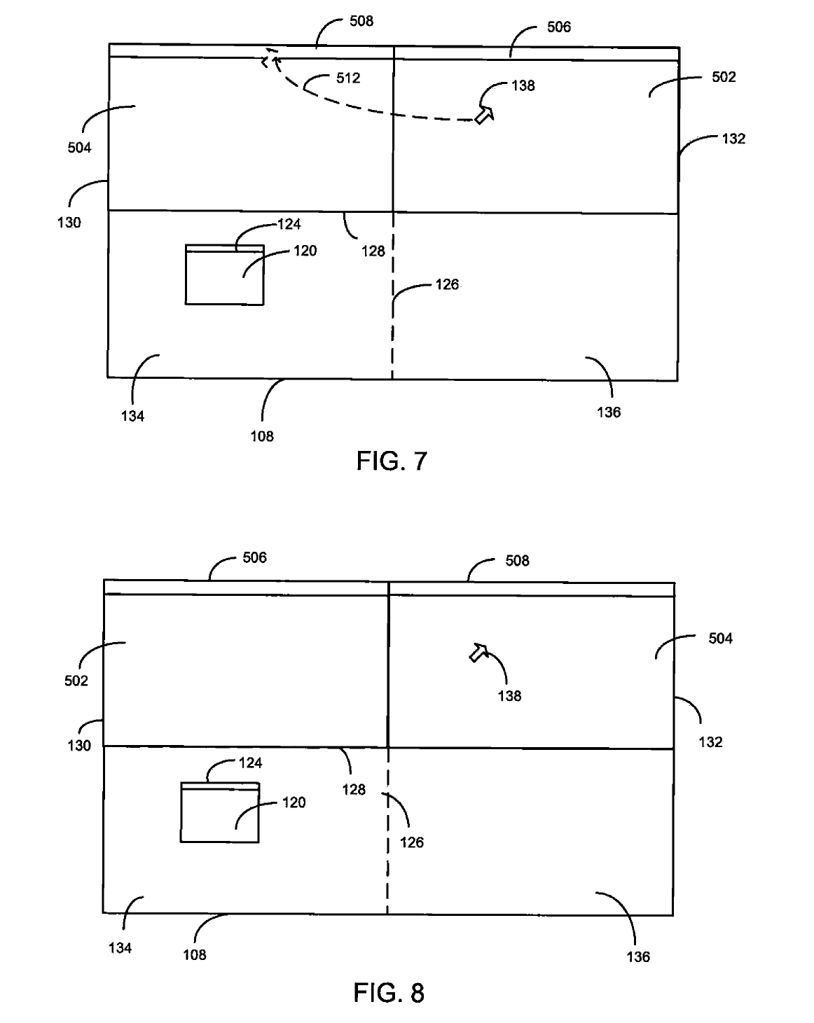

Turning to FIGS. 7 and 8, an example is shown where the second application window 502 is also attached to the grid and that instead of placing first application window 502 in a detached state after the grid-based swapping operation, the first application window 502 is attached to the grid section to which second application window 502 was attached before the grid-based swapping operation. For example, as shown in FIG. 7, first application window 502 is attached to grid section 132 and second application window 504 is attached to grid section 130. User input 512 represents a drag and drop operation, for example, where a user clicks title bar 508 of application window 504, drags the application window over a portion of grid section 132 (perhaps while pressing a modifier key or providing other user input), and releasing the mouse (i.e., performing a drag and drop operation). The result of the grid-based swapping operation is then illustrated in FIG. 8. As shown, second application window 502 is now attached to grid section 130 and application window 504 is now attached to grid section 132.

It is further contemplated, in another example, that based on the user input 512 and a current screen position, the one or more processing devices 102 may output visual indication data (which is a type of display data 116, for example) for displaying an indication that user will perform the grid-based swapping operation if a drop occurs at the current screen position. For example, the grid section to which the swapping operation will apply could change colors, the display may show a word (e.g., “swap”) or symbol that indicates a drop (i.e., a release of the mouse button) at the current location the grid management system will perform a grid-based swapping operation. This is also illustrated in FIG. 5 where portions of grid lines 126, 128 forming grid section 132 are solid lines, as discussed above.

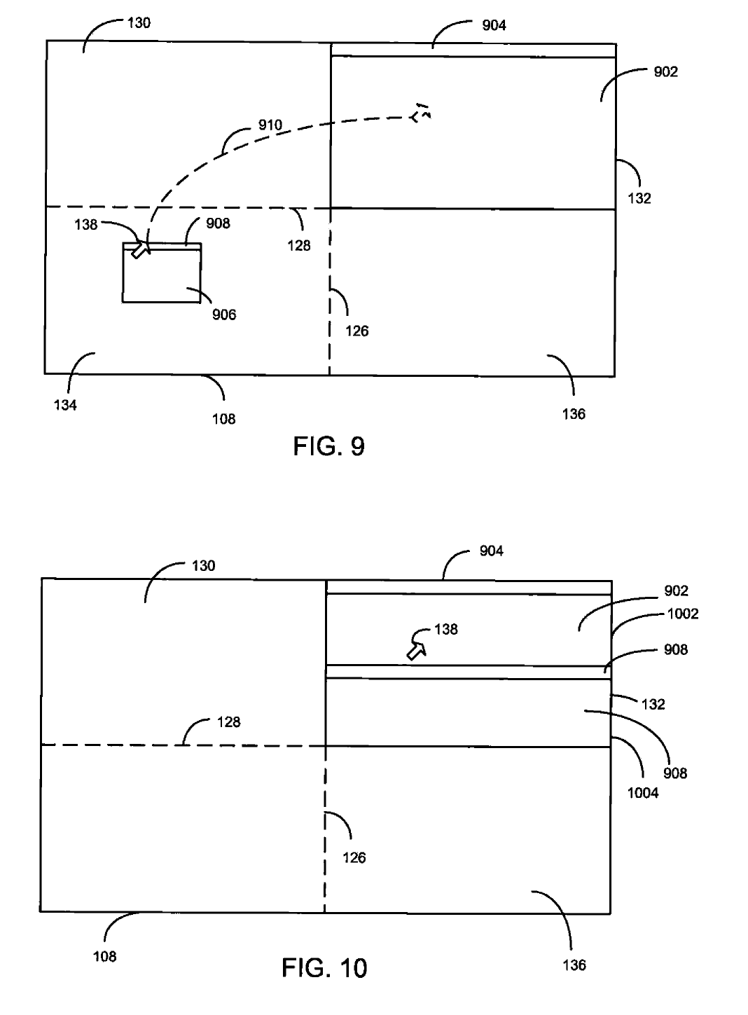

Turning now to FIGS. 9-12, another example of a grid management operation is shown, namely, a grid-based splitting operation. In these examples, first application window 902 has title bar 904 and second application window 906 has title bar 908. Although these application windows could be the same as application windows 502 and 504, different numbers have been used to show that they may also be different. It is understood, however, that the disclosure may apply to any suitable application windows. As shown in FIG. 9, user input 910, represented by a dotted line, is associated with second application window 906. For example, user input 910 may involve clicking title bar 908 with mouse pointer 130, dragging the mouse pointer over grid section 132, and dropping (releasing) the mouse button. As shown in FIG. 10, the one or more processing devices 102 may perform a grid-based splitting operation that causes the first grid section 132 to divide into a first new grid section 1002 and a second new grid section 1004. This division of grid section 132 is a creation of two new grid sections 1002 and 1004 that collectively take up the same screen space as the original grid section 132. Furthermore, the first application window 902 attaches to the first new grid section 1002 and the second application window 906 attaches to the second new grid section 1004.

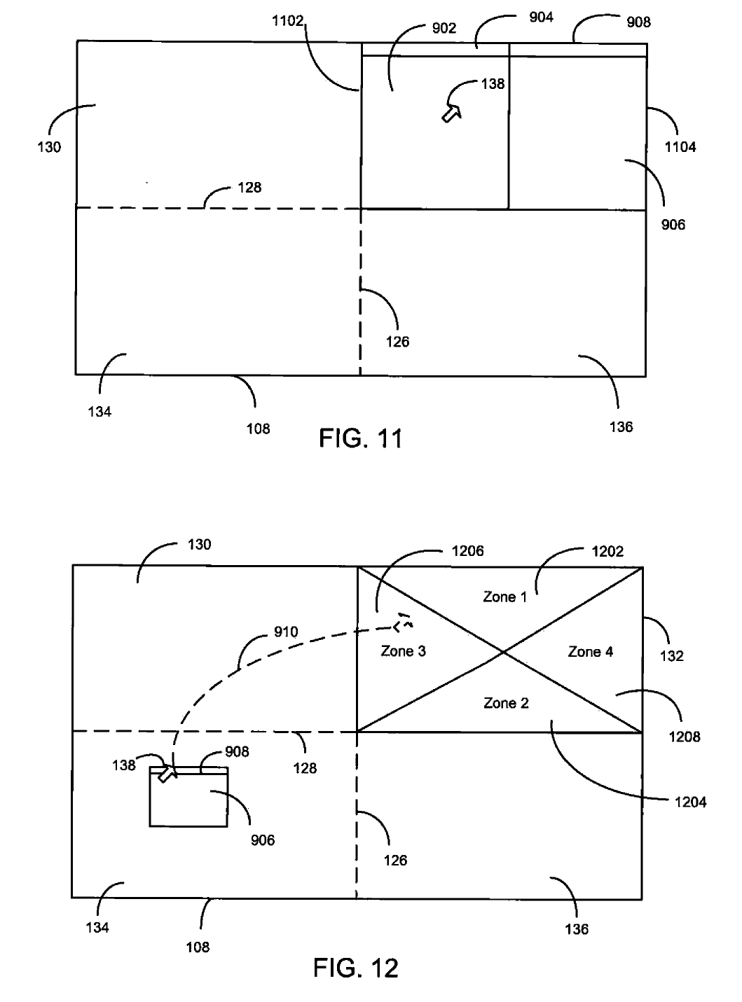

In the example illustrated in FIG. 10, the grid section 132 has been automatically divided into new grid sections 1002 and 1004, which are positioned vertically on top of each other as shown. Thus, the grid section 132 has vertically divided to create two equally sized new grid sections 1002 and 1004 vertically positioned on top of each other. It is understood, however, that grid section 132 may be split in any suitable manner and does not have to create two new equally-sized grid sections. It is also understood that the new grid sections need not be formed by horizontally splitting grid section 132. For example, FIG. 11 illustrates an example where grid section 132 has been split into two new grid sections 1102 and 1104 that are next to each other instead of on top of each other. Thus, grid section 132 has been split vertically to create two new grid sections 1102, 1104 that are horizontally next to each other.

Whether grid section 132 splits vertically, horizontally, or in another manner and whether the new grid sections are equal in size may be something that is predefined by a user or by the grid management system. In another example, however, the properties of the first new grid section and the properties of the second new grid section may be determined based on user input, current screen position, or any other suitable information, such as, for example, a configuration file or the application window itself. Properties may include, for example, the size of the grid section or sections (e.g., each could be but need not be split equally), positioning of each grid section, which application becomes attached to each new grid section, or any other suitable property associated with grid sections in a grid management system. In the example illustrated in FIG. 12, different zones are defined, including zone 1 (1202), zone 2 (1204), zone 3 (1206), and zone 4 (1208). These zones may be invisible but known to a user, although there may also be a visual indication, as illustrated, that is outputted to indicate the grid management system will perform a splitting operation if a drop occurs at the current screen position.

Furthermore, however, as illustrated, the visual indication may also indicate how the grid section 132 will split. Even if there is not a visual indication to indicate how the grid section will be split based on the user input, the user input may still determine how the grid section 132 will split. For example, as shown in FIG. 12, if a user drops a second application window 906 in zone 2 (1204), grid section 132 may be split similar to the way shown in FIG. 10, i.e., a horizontal split with the first application window 902 in a new grid section 1002 that is above new grid section 1004, which contains second application window 906. Alternatively, if the user drops the second application window 906 in zone 4 (1208), grid section 132 may split as shown in FIG. 11, for example, i.e., grid section 132 is split vertically with first application window 902 in the left new grid section 1102 and with second application window 906 in the right new grid section 1104.

Other features of a grid-based splitting operation are contemplated. For example, if an application window 906 shown in FIG. 11 is detached from grid section 1104, perhaps in response to receiving user input, an empty grid section 1104 may be left while grid section 1102 remains with application window 902. Since grid sections 1102 and 1104 were formed from a larger grid section 132 being split, the detaching of one application window may cause the first new grid section 1102 to merge with the second new grid section 1104 to form a merged grid section, which may be the same as the previous grid section 132. In other words, the merged grid section may take up the same screen space as the grid section 132 took up before the grid-based splitting operation.

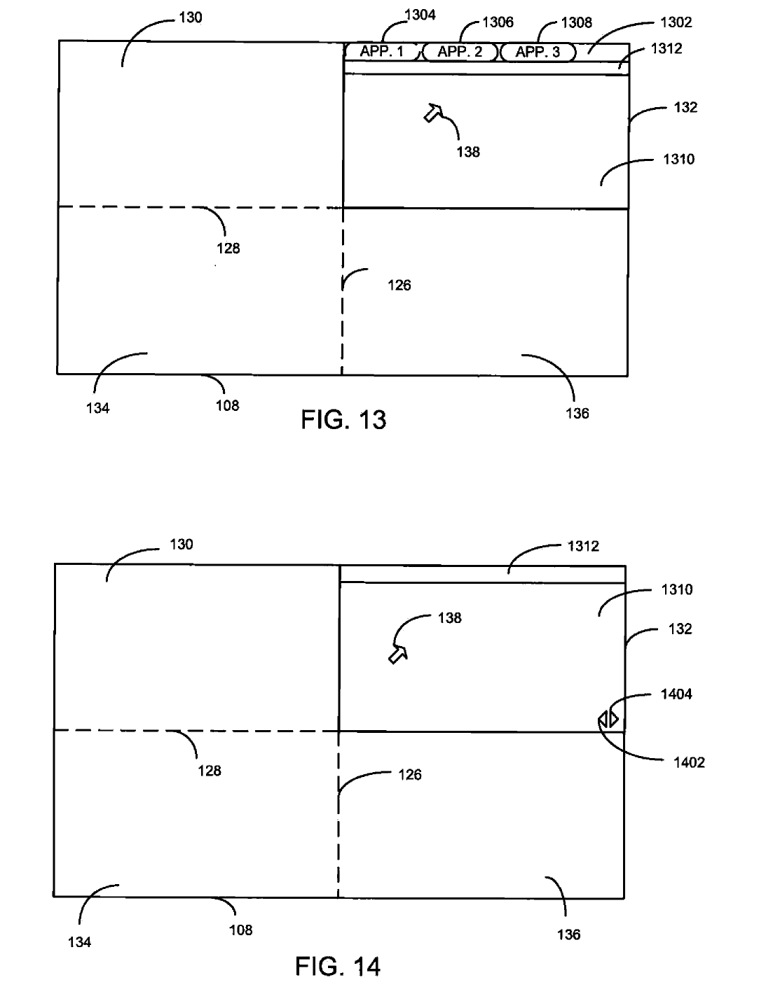

FIGS. 13-15 show another example of a grid management operation, namely a grid-based sharing operation. A grid-based sharing operation places both a first application window and a second application window in the same grid section that allows user control through a graphical user interface over displaying either the first application window in the grid section or the second application window in the grid section. This user control may be direct and through an intuitive graphical user interface. It is understood, however, that a grid-based sharing operation may allow any number of application windows to share a grid section, i.e., the number is not limited to two.

FIG. 13 is one example illustrating the result of a grid-based sharing operation. In this example, grid section 132 has three application windows attached to it, each associated with a different application: App. 1, App. 2, and App. 3. In the example shown in FIG. 13, a tab bar 1302 contains tabs 1304, 1306, and 1308, which a user may click to bring another application window to the forefront of the grid section. Thus, for example, application window 1310, having title bar 1312, is attached to grid section 132 and is in front of the other application windows (not visible in this view) that are also attached to grid section 132. Tab bar 1302, however, displays a tab 1304, 1306, and 1308, which is a visual representation of each application window attached to grid section 132. As shown, tab 1304 is shown differently (dotted lines) than tabs 1306 and 1308 because it is associated with application window 1310, which is currently in front of all of the other application windows attached to grid section 132. Furthermore, the tabs 1304, 1306, and 1308 allow a user to intuitively and quickly bring a different application window to the front of the grid section so that a user may view it. For example, if a user wishes to bring the application window that contains App. 2 to the forefront of grid section 132, the user may click tab 1306. It is understood that any other suitable user input may achieve the same effect. Having a tab bar 1302 provides a fast and efficient way for a user to bring a different application window to the forefront of a grid section, yet one skilled in the art will recognize that some screen space is sacrificed to make room for the tab bar 1302.

The example shown in FIG. 14 does not take up as much screen space as a tab bar 1302. This example of a grid-based sharing operation, which may be in response to a drag and drop operation, allows user control through a graphical user interface to determine which application window to display in a grid section. In this example, application window 1310 is shown at the forefront of grid section 132, yet other application windows (not visible) are also attached to grid section 132. This example, however, includes previous button 1402 and next button 1404 which may allow a user to cycle through the application windows that are attached to grid section 132. The previous button 1402 and next button 1404 may be rendered into a portion of the grid section and/or overlayed on top of the top-most application window in the grid section, as one skilled in the art will appreciate.

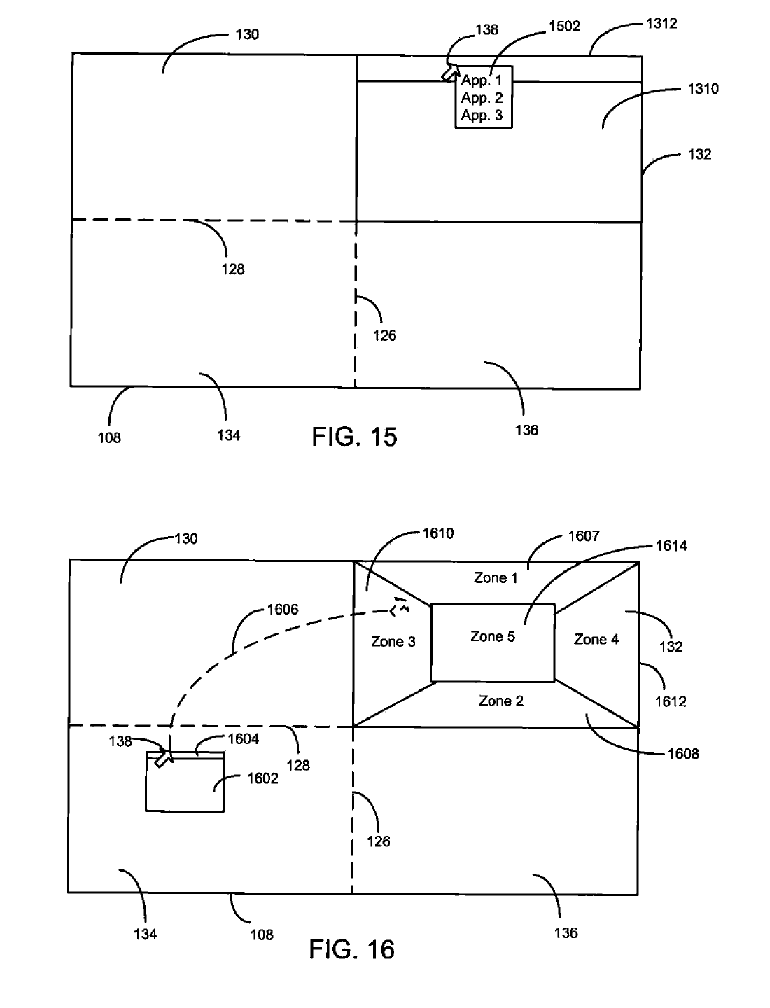

Yet another example of a grid-based sharing operation is illustrated in FIG. 15. In this example, a user may use mouse pointer 138 to provide user input, such as a right-click on the title bar 1312, which will provide a context menu 1502. This context menu 1502 lists the application windows that are attached to grid section 132. A user may then, for example, select an application in the context menu 1502 that he or she wishes to bring to the forefront of the grid section 132. As one skilled in the art will appreciate, this example of a grid-based sharing operation does not require any screen space as a tab bar 1302 does and does not interfere with the display of the application window as overlaying a previous button 1402 or a next button 1404 may. This example grid-based sharing operation, however, may be less user intuitive, but it still provides a quick, direct method of bringing a different application window to the forefront of gird section 132.

As one skilled in the art will recognize, the above-described grid-management operations may be used alone or in combination and may be used in any suitable order. For example, a grid-based splitting operation may be performed, and then a user may cause the apparatus to perform a grid-based swapping operation. User input may differ to indicate a desire to perform different grid-based management operations, as one skilled in the art will recognize. For example, a user may hold down one modifier key while dragging and dropping to indicate a desire to perform a grid-based swapping operation, while the user may hold down a different modifier key while dragging and dropping to indicate a desire to perform a grid-based splitting operation. As one skilled in the art will appreciate, endless possibilities exist for a user to perform different grid management operations. It is further recognized that the apparatus may be in distributed form. Thus, for example, any component of the apparatus, such as memory 104 or one or more processing devices 102, may be remote and may, for example, send and/or receive output display data 116 or memory data 114 through a network, such as a wired or wireless network.

FIG. 16 illustrates another example wherein application window 1602, having title bar 1604, is detached from the grid. Using mouse pointer 138, along with any other suitable input such as a modifier key, a user may give user input 1606 represented by the dotted line 1606 to drag the application window 1602 over grid section 132. The screen location at which the drop occurs then determines what grid-based operation to perform. As illustrated, there may also be some visual indication as to what operation will occur if a drop occurs at various screen positions. For example, as shown in FIG. 16, a visual indication is shown that includes zone 1 (1607), zone 2 (1608), zone 3 (1610), zone 4 (1612), and zone 5 (1614). If the drop occurs in zone 1 (1606), a grid-based splitting operation may occur that divides the gird section horizontally into two new grid sections with the dragged application being on top of the application that was previously in grid section 132. Alternatively, if the drop occurs in zone 2 (1608), then a grid-based splitting operation may occur that divides the gird section horizontally into two new grid sections with the dragged application being on the bottom of the application that was previously in grid section 132. Similarly, dropping in zone 3 (1610) and zone 4 (1612) may perform a grid-based splitting operation where grid section is split along a vertical line. If the drop occurs in a screen position within the area defined as zone 5 (1614), however, a grid-based swapping operation is performed, as described above.

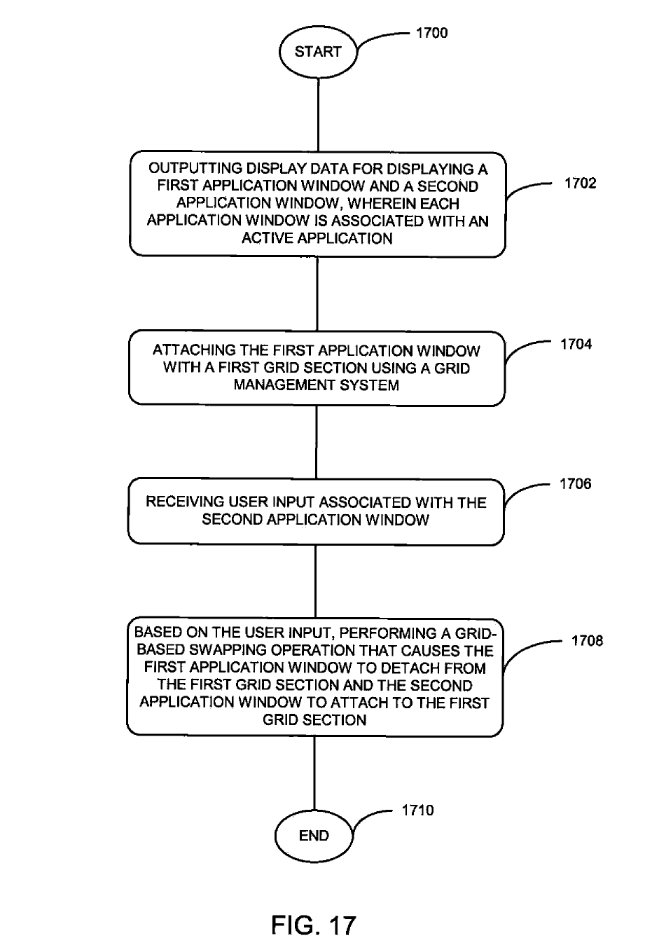

Turning now to FIG. 17, a method is shown. The method may be performed on an apparatus such as that described above, but it is understood that any suitable apparatus or device may be used. Furthermore, it is understood that this example method and the steps disclosed herein may be performed in any suitable order and may further include additional suitable steps before the method, after the method, or dispersed between the steps of the method shown.

The method starts as shown in block 1700. The method includes, as shown in block 1702, outputting display data for displaying a first application window and a second application window, wherein each application window is associated with an active application. As shown in block 1704, the method may further include attaching the first application window with a first grid section using a grid management system. Next, as shown in block 1706, the method includes receiving user input associated with the second application window. As described above, this user input may come from any suitable input device, such as a mouse, a keyword, or any suitable input device known in the art. Next, as shown in block 1708, the method may include, based on the user input, performing a grid-based swapping operation that causes the first application window to detach from the first grid section and a second application window to attach to the first grid section. The method then ends as shown in block 1710.

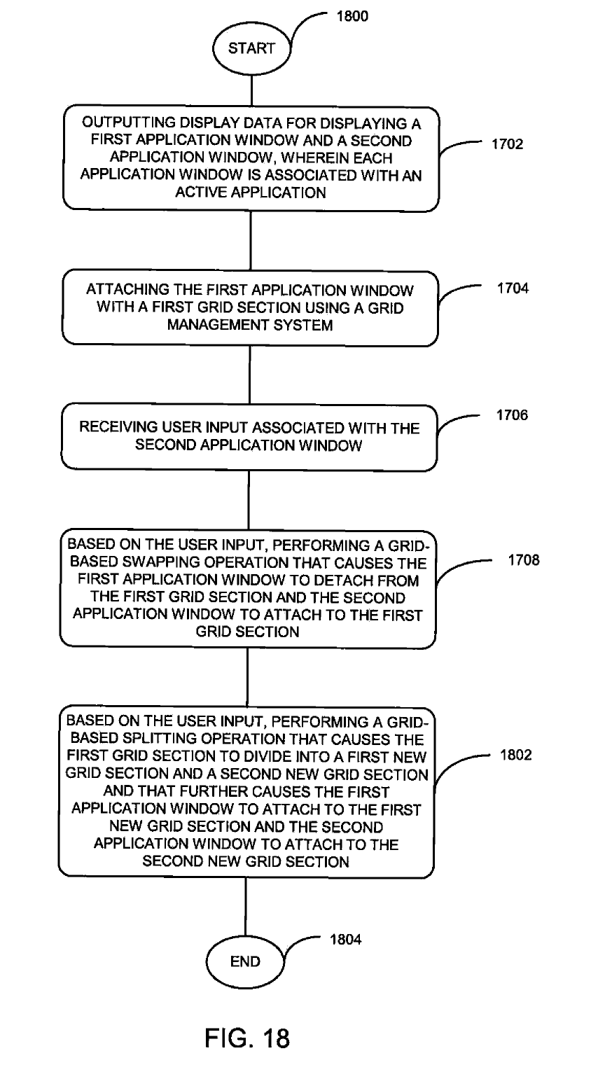

As mentioned above, the message may include any additional steps at any suitable location within the steps of the method here shown. For example, FIG. 18 shows a new method that starts as shown in block 1800. This message includes steps that are included in the method described in FIG. 17, namely step 1702, 1704, 1706, and 1708. After the step shown in block 1708, however, an additional step is shown in block 1802, which includes, based on the user input, performing a grid-based splitting operation that causes the first grid section to divide into the first new grid section and a second new grid section and that further cause the first application window to attach to the first new grid section and the second application window to attach to the second new grid section.

As mentioned, these methods may include any additional suitable steps either before, between, or after the steps described. For example, the disclosure above in relation to the apparatus further indicates additional steps that one may include in a method. For example, the method may include, based on user input, performing a grid-based sharing operation that places both a first application window and a second application window in the same grid section and allows user control through a graphical user interface over displaying either the first application window in the grid section or the second application window in the grid section. Other suitable steps of the method will be recognized by one skilled in the art in view of the present disclosure.

Thus, among other advantages, users will be able to gain all of the advantages associated with grid management systems while being able to more quickly and more intuitively interact with the grid management system. Thus, users will be able to more quickly perform grid-based operations, thereby enhancing organization of open application windows and increasing user productivity.

The above detailed description of the disclosure and the examples described therein have been presented for the purposes of illustration and description only and not by limitation. It is therefore contemplated that the present disclosure cover any and all modifications, variations or equivalents that fall within the spirit and scope of the basic underlying principles disclosed above and claimed herein.

What is claimed is:

1. An apparatus comprising:
one or more processing devices operative to execute stored computer readable instructions; and
memory containing stored computer readable instructions executable by the one or more processing devices that, when executed by the one or more processing devices, cause the one or more processing devices to:
output display data for displaying a first application window and a second application window, wherein each application window is associated with an active application;
attach the first application window with a first grid section using a grid management system; and
based on user input associated with the second application window, perform a grid-based swapping operation that causes the first application window to detach from the first grid section and the second application window to attach to the first grid section.

2. The apparatus of claim 1 wherein the grid-based swapping operation further causes the first application window to either attach to the second grid section if the second application window was attached to the second grid section before the swapping operation or to remain detached if the second application window was detached from the second grid section before the swapping operation.

3. The apparatus of claim 1 wherein the memory comprises computer readable instructions, that when executed by the one or more processing devices, further cause the one or more processing devices to perform the grid-based swapping operation in response to a drag and drop input associated with the second application window.

4. The apparatus of claim 1, wherein the computer readable instructions, when executed by the one or more processing devices, further cause the one or more processing devices to:
based on the user input and a current screen position, output visual indication data for displaying an indication that a user will perform the grid-based swapping operation if a drop occurs at the current screen position.

5. An apparatus comprising:
one or more processing devices operative to execute stored computer readable instructions; and
memory containing stored computer readable instructions executable by the one or more processing devices that, when executed by the one or more processing devices, cause the one or more processing devices to:
output display data for displaying a first application window and a second application window, wherein each application window is associated with an active application;
attach the first application window with a first grid section using a grid management system; and
based on user input associated with the second application window, perform a grid-based splitting operation that causes the first grid section to divide into a first new grid section and a second new grid section and that further causes the first application window to attach to the first new grid section and the second application window to attach to the second new grid section.

6. The apparatus of claim 5 wherein the memory comprises computer readable instructions, that when executed by the one or more processing devices, further cause the one or more processing devices to perform the grid-based splitting operation in response to a drag and drop input associated with the second application window.

7. The apparatus of claim 5, wherein the computer readable instructions, when executed by the one or more processing devices, further cause the one or more processing devices to:
based on the user input and a current screen position, determine properties of the first new grid section and properties of the second new grid section.

8. The apparatus of claim 7, wherein the computer readable instructions, when executed by the one or more processing devices, further cause the one or more processing devices to:
based on the user input and the current screen position, output visual indication data for displaying an indication that a user will perform the grid-based splitting operation if a drop occurs at the current screen position.

9. The apparatus of claim 7, wherein the computer readable instructions, when executed by the one or more processing devices, further cause the one or more processing devices to:
detach the first application window from the first new grid section or the second application window from the second new grid section, thereby leaving an attached application window; and
merge the first new grid section and the second new grid section into a merged grid section.

10. An apparatus comprising:
one or more processing devices operative to execute stored computer readable instructions; and
memory containing stored computer readable instructions executable by the one or more processing devices that, when executed by the one or more processing devices, cause the one or more processing devices to:
output display data for displaying a first application window and a second application window, wherein each application window is associated with an active application;
attach the first application window with a grid section using a grid management system; and
based on user input associated with the second application window, perform a grid-based sharing operation that places both the first application window and the second application window in the same grid section and allows user control through a graphical user interface over displaying either the first application window in the grid section or the second application window in the grid section.

11. The apparatus of claim 10 wherein the memory comprises computer readable instructions, that when executed by the one or more processing devices, further cause the one or more processing devices to perform the grid-based sharing operation in response to a drag and drop input associated with the second application window.

12. The apparatus of claim 10 wherein the user control is received via one of the following interfaces: a tab bar; a next/previous button; and a context menu.

13. A storage medium containing stored computer readable instructions executable by one or more processing devices that, when executed by the one or more processing devices, cause the one or more processing devices to:
output display data for displaying a first application window and a second application window, wherein each application window is associated with an active application;
attach the first application window with a first grid section using a grid management system; and
based on user input associated with the second application window, perform a grid-based splitting operation that causes the first grid section to divide into a first new grid section and a second new grid section and that further causes the first application window to attach to the first new grid section and the second application window to attach to the second new grid section.

14. The storage medium of claim 13 wherein the computer readable instructions, when executed by the one or more processing devices, further cause the one or more processing devices to:
based on the user input, perform a grid-based swapping operation that causes the first application window to detach from the first grid section and the second application window to attach to the first grid section.

15. The storage medium of claim 13 wherein the computer readable instructions, when executed by the one or more processing devices, further cause the one or more processing devices to:
based on the user input and a current screen position output visual indication data for displaying an indication that a user will perform either the grid-based splitting operation or the grid-based swapping operation if a drop occurs at the current screen position.

16. A method comprising:
outputting display data for displaying a first application window and a second application window, wherein each application window is associated with an active application;
attaching the first application window with a first grid section using a grid management system;
receiving user input associated with the second application window; and
based on the user input, performing a grid-based swapping operation that causes the first application window to detach from the first grid section and the second application window to attach to the first grid section.

17. The method of claim 16 further comprising:
based on the user input, performing a grid-based splitting operation that causes the first grid section to divide into a first new grid section and a second new grid section and that further causes the first application window to attach to the first new grid section and the second application window to attach to the second new grid section.

18. The method of claim 17 further comprising:
performing a grid-based sharing operation that places both the first application window and the second application window in the grid section and allows user control over displaying either the first application window in the grid section or the second application window in the grid section.

19. The method of claim 17 further comprising:
based on the user input and a current screen position, outputting visual indication data for displaying an indication that a user will perform either the grid-based splitting operation or the grid-based swapping operation if a drop occurs at the current screen position.

20. The method of claim 17 further comprising:
based on the user input and a current screen position, determining properties of the first new grid section and properties of the second new grid section.
